(19) United States
(12) Patent Application Publication
(10) Pub. No.: US 2009/0058671 A1
(43) Pub. Date: Mar. 5, 2009

(54) Position detector

(76) Inventor: George Lin, Yung Kang City (TW)

Correspondence Address: PRO-TECHTOR INTERNATIONAL SERVICES, 20775 NORADA CT., SARATOGA, CA, 95070, US

(21) Appl. No.: 11/897,840

(22) Filed: Aug. 31, 2007

(51) Int. Cl. G08B 21/00

(52) U.S. Cl. 340/686.1

(57) ABSTRACT

A position detector comprises a body having a chamber. The chamber includes a first bottom surface, a second bottom surface and a top portion. The first bottom surface is a horizontal surface, the second bottom surface is an inclined surface and is connected to an end of the first bottom surface, and the top portion is an inclined surface that is located correspondingly to the inclined direction of the second bottom surface. A ball is received in the chamber of the body and can be rolled freely. A transmission member serves to transmit a first signal that is passed through the chamber of the body, and a receiving member is provided for receiving the first signal transmitted from the transmission member. Thereby, when the ball covers the first signal exceeds a predetermined time, the receiving member will output a second signal for controlling.

### BACKGROUND OF THE INVENTION

1. Field of the Invention

The present invention relates to a position detector, and more particularly to a position detector which can be used to various kinds of electronic products, so as to control the open and close condition of the electronic products automatically.

2. Description of the Prior Art

Position detector has been widely used to various kinds of electronic products such as the electric iron, electronic toy, and other purchasing products that are controlled to output a control signal under a certain condition automatically, so as to control the open and close condition of such electronic products.

For example, electric iron is one kind of ordinary household appliance products for ironing clothes, which has won the consumer's favor. However, when in use, an ironing surface of the electric iron must be heated to reach a certain high temperature for ironing clothes, so in order to protect the clothes, the electric iron have to move on the clothes to and fro. If the high temperature ironing surface stays at the clothes for a long time which exceeds the allowable temperature of the clothes due to the carelessness of the user, the clothes is likely to be burnt, and even it is dangerous. However, the problems of the contact resistance or electroplated abrasion of the metal ball will influence open and close condition of the electronic products. Thereby, finding a position detector uses a metal ball as a conductor which can output a signal to cut off the power source in terms of safety has become an important issue for the manufacturers.

The present invention has arisen to mitigate and/or obviate the afore-described disadvantages.

### SUMMARY OF THE INVENTION

The primary objective of the present invention is to provide a secure position detector.

To achieve the object of the present invention, the position detector comprises a body having a first leg group, a second leg group and a chamber. The chamber includes a first bottom surface, a second bottom surface and a top portion. The first bottom surface is a horizontal surface, the second bottom surface is an inclined surface and is connected to an end of the first bottom surface, and the top portion is an inclined surface that is located correspondingly to the inclined direction of the second bottom surface. A ball is received in the chamber of the body and can be rolled freely. A transmission member serves to transmit a first signal that is passed through the chamber of the body, and a receiving member is provided for receiving the first signal transmitted from the transmission member. When the body is moved horizontally, the ball will be moved in the chamber freely and will not stop at a position exceeds a predetermined time, so the body is in the condition of connecting. Contrarily, when the body is not moving, the ball will roll to the first bottom surface of the chamber to cover the first signal transmitted from the transmission member, such that the receiving member cannot receive the first signal transmitted from the transmission member and will output a second signal after exceeding the predetermined time.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a position detector in accordance with the present invention;

FIG. 2 is an illustrative view showing the structure of the position detector in accordance with the present invention;

FIG. 3 is an illustrative view showing the moving of the position detector in accordance with the present invention; and

FIG. 4 is an illustrative view showing the working condition of the position detector when a ball being moved left and right, wherein a cover is not shown.

### DETAILED DESCRIPTION OF THE PREFERRED EMBODIMENTS

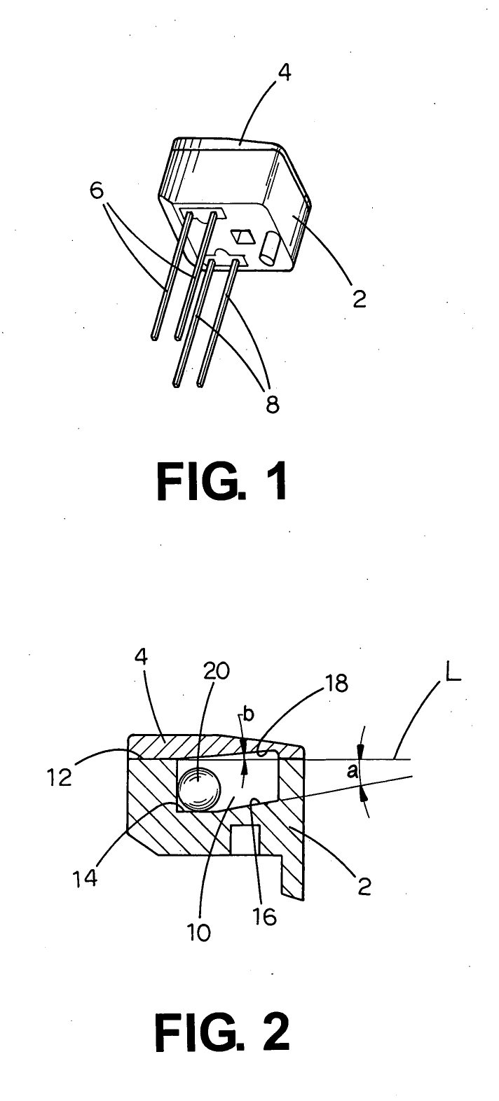

Referring to FIG. 1, a position detector in accordance with the present invention comprises a body 2 and a leg group. The body 2 includes a cover 4. The leg group in the present embodiment includes four legs, that is a first leg group 6 and a second leg group 8. The first leg group 6 has two legs that are electrically connected to each other. Also, the second leg group 8 has two legs that are electrically connected to each other.

Referring to FIG. 2, the body 2 further includes a chamber 10. Outside the chamber 10 is defined an engaging surface 12 for positioning the cover 4. The chamber 10 includes a first bottom surface 14, a second bottom surface 16 and a top portion 18. The first bottom surface 14 is a horizontal surface, the second bottom surface 16 is an inclined surface and is connected to an end of the first bottom surface 14. And cooperates with the inclined direction of the second bottom surface 16, the top portion 18 is designed to an inclined surface.

A ball 20 is received in the chamber 10 of the body 2. An angle a is formed between the second bottom surface 16 of the chamber 10 and a horizontal surface L, such that the ball 20 can be moved horizontally. Moreover, an angle b is formed between the top portion 18 and the horizontal surface L, such that the ball 20 can be moved smoothly, and the body 2 can be worked normally when the body 2 is installed reversely.

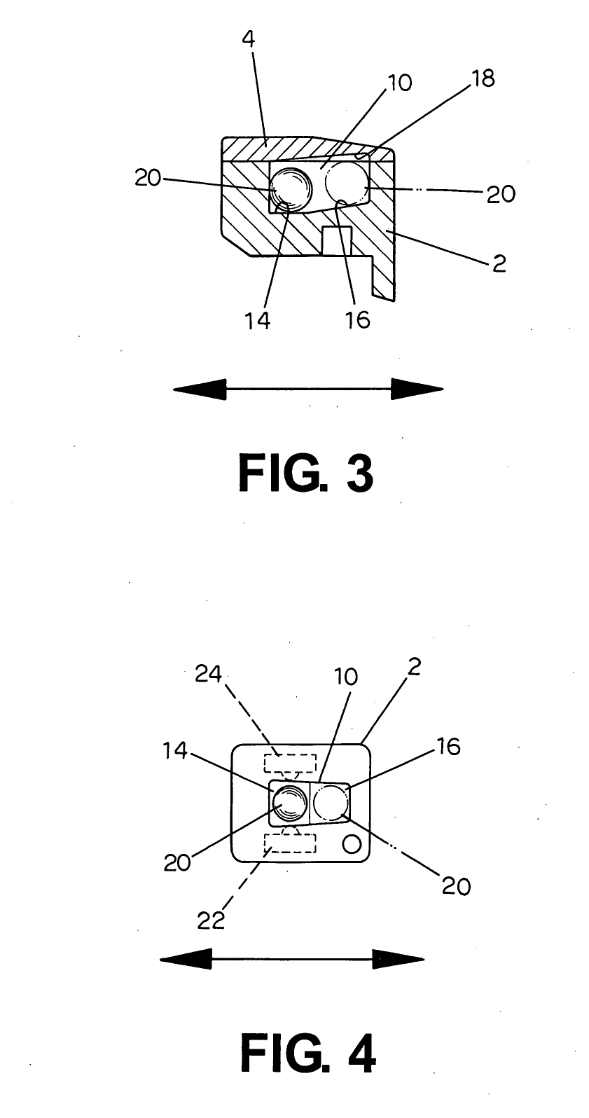

Referring to FIG. 3, when the body 2 is moved horizontally, the ball 20 will be moved in the chamber 10 freely (moved left and right). And since the first bottom surface 14 of the chamber 10 is the horizontal surface, and the second bottom surface 16 is the inclined surface, the ball 20 will be stopped at the first bottom surface 14 (horizontal surface) finally.

Referring to FIG. 4, the body 2 further includes a detection assembly having a transmission member 22 and a receiving member 24.

The transmission member 22 is electrically connected to the first leg group 6 of the body 2 and is provided for transmitting a first signal (such as infrared ray), and the path of the first signal is passed through the chamber 10 of the body 2. In the present embodiment, the path of the first signal is preferably passed through the first bottom surface 14 of the chamber 10, such that when the body 2 is not moving, the ball 20 will stop at the first bottom surface 14 of the chamber 10 to cover the first signal transmitted from the transmission member 22 rightly.

The receiving member 24 is electrically connected to the second leg group 8 of the body 2 and is provided for receiving the first signal transmitted from the transmission member 22.

By such arrangements, when the body 2 is not moving, the ball 20 will stop at the first bottom surface 14 of the chamber 10 to cover the first signal transmitted from the transmission member 22 rightly. When the receiving member 24 not receiving the first signal transmitted from the transmission member 22 exceeds a predetermined time, the receiving member 24 will output a second signal for controlling.

For example, the position detector of the present invention can be installed on/in electronic products such as an electric iron. When in use, the electric power of the electric iron is usually connected. And when the electric iron is electrified and is placed on the clothes, the ball 20 will stop at the first bottom surface 14 of the chamber 10. If the ball 20 stops exceed the predetermined time, the receiving member 24 will output the second signal to cut off the power source of the electric iron automatically, so as to ensure the safety of using.

Thereby, the present invention utilizes the ball 20 to cover the first signal transmitted from the transmission member 22, such that the receiving member 24 will output the second signal for cutting off the power source after not receiving the first signal transmitted from the transmission member 22. When the body 2 is moved horizontally, the ball 20 will move in the chamber 10 freely and depart from the first bottom surface 14 of the chamber 10, enabling the receiving member 24 to work normally by receiving the first signal transmitted from the transmission member 22. Obviously, the moving position and the stopping time of the ball 20 controls the working condition of the electronic products.

The above-mentioned transmission member 22 and the receiving member 24 are disposed at the opposite sides outside the chamber 10 of the body 2.

The ball 20 electrically connected to a control unit or by the electrical design enables the position detector to work after exceeding the predetermined time.

Thereby, when the body 2 is moved horizontally, the ball 20 will be moved in the chamber 10 freely (such as moved left and right) and will not stop at a position exceeds the predetermined time, so the body 2 is in the condition of connecting. Contrarily, when the body 2 is not moving, the ball 20 will move to the first bottom surface 14 of the chamber 10 to cover the first signal transmitted from the transmission member 22, such that the receiving member 24 cannot receive the first signal transmitted from the transmission member 22 and will output the second signal after exceeding the predetermined time for cutting off the power source of the electronic products.

By such arrangements, the present invention solves the conventional problem of the contact resistance or electroplated abrasion of the conventional position detector by using a metal ball as a conductor. The ball 20 of the present invention is not used as the conductor, but as a cover, which can be used to various kinds of electronic products, especially the electric iron, electronic toy, and other purchasing products that are controlled to output a control signal automatically under a certain condition, so as to control the open and close condition of such electronic products. Therefore, the present invention is secure and energy-saving.

While we have shown and described various embodiments in accordance with the present invention, it should be clear to those skilled in the art that further embodiments may be made without departing from the scope of the present invention.

What is claimed is:

1. A position detector, comprising:
a body formed with a chamber having a first bottom surface, a second bottom surface and a top portion, the first bottom surface being a horizontal surface, the second bottom surface being an inclined surface and connected to an end of the first bottom surface, the top portion being an inclined surface that is located correspondingly to an inclined direction of the second bottom surface;
a transmission member for transmitting a first signal that is passed through the chamber of the body;
a receiving member for receiving the first signal transmitted from the transmission member; and
a ball received in the chamber of the body, when the body is not moving, the ball will roll to the first bottom surface of the chamber to cover the first signal transmitted from the transmission member, and the receiving member will output a second signal if not receives the first signal transmitted from the transmission member exceeds the predetermined time.

2. The position detector as claimed in claim 1, wherein outside the chamber is defined an engaging surface for positioning a cover.

3. The position detector as claimed in claim 1, wherein the first signal transmitted from the transmission member is an infrared ray.

4. The position detector as claimed in claim 1, wherein the transmission member and the receiving member are disposed at the opposite sides outside the chamber of the body.
